(19) United States
(12) Patent Application Publication
(10) Pub. No.: US 2016/0163121 A1
(43) Pub. Date: Jun. 9, 2016

(54) SYSTEM AND METHOD FOR VEHICLE RETRIEVAL

(71) Applicant: Angela Lea MARTIN, Decatur, GA (US)

(72) Inventor: Angela Lea MARTIN, Decatur, GA (US)

(21) Appl. No.: 14/961,125

(22) Filed: Dec. 7, 2015

Related U.S. Application Data
(60) Provisional application No. 62/088,180, filed on Dec. 5, 2014.

(51) Int. Cl. G07B 15/02

(52) U.S. Cl. CPC G07B 15/02; G06Q 50/30

(57) ABSTRACT

Exemplary embodiments disclosed herein relate to methods, mediums, and systems for remotely summoning a vehicle, such as from a valet service, using a mobile device. Exemplary embodiments may be implemented as a “software as a service” application on a patron's electronic device for valet parking companies that allow restaurant patrons and the like to remotely summon their vehicle and pay/tip in the application's interface. A predictive algorithm displays a timer to show patrons their place in queue. The algorithm may consider the time required to retrieve the vehicle and the number of patrons ahead of the requesting patron in a queue. If there is a line the patron can pay a fee (e.g., $10) to jump the line. The predictive algorithm may then re-calculate the amount of time required to retrieve the vehicle. Exemplary embodiments may reduce patron frustration, reduce valet related expenses, and increase valet related revenue, while monitoring employee whereabouts.

### CLAIM FOR PRIORITY

This application claims priority to the U.S. Provisional Patent Application No. 62/088,180 filed on Dec. 5, 2014 in the United States Patent and Trademark Office (USPTO), the entire contents of which are hereby incorporated by reference.

### TECHNICAL FIELD

Various example embodiments of the present application relate generally to remotely summoning a vehicle, such as from a valet service. More particularly, the present application relates to methods, mediums, and systems than can be used to allow patrons and the like to remotely summon their vehicle and pay and/or tip using an application's interface in a mobile device.

### BACKGROUND

In a traditional valet service, a patron may drive their vehicle to a location, such as a restaurant, and leave the vehicle with a valet. The valet may give a claim ticket to the patron and park the vehicle at a remote location. When the patron is ready to leave, the patron may return to a valet stand and give their claim ticket to the valet. The valet may then retrieve the vehicle associated with the claim ticket and return the vehicle to the patron.

A number of problems may arise in the conventional valet scenario. For example, if multiple patrons are attempting to retrieve their vehicles at the same time, a line may form which delays subsequent patrons from being able to leave quickly and thus, inconveniencing and frustrating the patron. Because a patron typically does not know how long the line will be until they arrive at the valet stand, the patron may have to wait a long time (potentially outside in inclement weather). There is typically nothing a patron can do to alleviate a long wait, even though the patron might be willing to incur increased cost for a shorter wait. For example, if a first patron has no pressing need to leave a restaurant immediately, but a second patron needs to arrive home quickly, for example in order to relieve a babysitter, the second patron might be willing to incur an increased cost to jump ahead in the line. This would be preferable from the perspective of the second patron, who needs to arrive home early, and the valet service, which could increase its revenues. Moreover, the first patron is unlikely to be significantly inconvenienced, because the first patron was not as concerned about the wait and is not willing to incur the increased costs of jumping ahead in the vehicle retrieval line.

Moreover, if a patron knew beforehand how long the wait would be for the patron's vehicle, the patron could plan ahead, either by sending a member of their party to request their vehicle early or by remaining comfortably at their table until the wait time had decreased.

Still further, once the valet has retrieved a vehicle for a patron, the patron may need to pay a valet fee and/or may wish to tip the valet. Traditionally, this has required that the patron carry sufficient cash to cover the valet fee and tip, which the patron may forget to do.

### SUMMARY

The present invention is directed to these and other problems associated with traditional valet services. Exemplary embodiments disclosed herein relate to methods, mediums, and systems for remotely summoning a vehicle, such as from a valet service, using a mobile device. A predictive algorithm operating on a patron's electronic device, a valet device, and/or a remote server may automatically calculate an estimated amount of time required to retrieve the vehicle. The algorithm may consider the time required to retrieve the vehicle and the number of patrons ahead of the requesting patron in a queue. If there are other patrons ahead of the requesting patron, the requesting patron may be provided with an option to pay a fee to move ahead in the line. The predictive algorithm may then re-calculate the amount of time required to retrieve the vehicle. This feedback regarding the time required to retrieve the vehicle may allow the patron to plan their actions accordingly, possibly saving time and frustration for the patron while possibly increasing revenue for the valet service.

Exemplary embodiments have a number of advantages over traditional valet services. By providing accurate estimates of when a vehicle will be ready for pickup in conjunction with the ability to summon the vehicle from a mobile device, the exemplary embodiments allow a patron to plan accordingly so that a vehicle will be ready when the patron is prepared to leave. Moreover, the valet service's revenue may be increased because of additional fees paid by users to move ahead in the line and by eliminating valet tickets. Furthermore, because valet employee and/or vehicle locations are monitored as part of the predictive algorithm, employers can keep better track of how efficiently their employees are being utilized.

In an exemplary embodiment, a method for summoning a vehicle using a computing-device, for example a mobile device, is provided. A message containing a request to retrieve a vehicle is transmitted by the patron using the computing-device. The computing-device, may either automatically, periodically, and/or on demand, calculate an estimated amount of time to deliver the vehicle. The estimated amount of time to deliver the vehicles may be determined based on an estimated amount of time to retrieve the vehicle, and/or an estimated amount of waiting time based on the request's position in a wait queue.

The computing-device may present an interface to the patron which allows the patron to request to be advanced in the vehicle retrieval wait queue. The computing-device may receive confirmation that the request should be advanced in the wait queue. The computing-device may then either automatically, periodically, and/or on demand, recalculate the estimated amount of time to deliver the vehicle based on an updated position for the request in the wait queue. The computing-device may collect a payment for retrieving the vehicle.

In another exemplary embodiment, the computing-device may acquire identifying information relating to a ticket issued to a user of the vehicle.

In determining the payment for retrieving the vehicle, the computing-device may include a fee for advancing the request of the patron in the wait queue. The computing-device may determine the fee based a number of positions that the request is advanced in the wait queue. The computing-device may determine the fee based on the request being advanced a predetermined number of positions in the wait queue. The computing-device may determine the payment for retrieving the vehicle includes a tip for a valet.

In another exemplary embodiment, the computing-device may estimate the time to deliver the vehicle based on a location of the vehicle and a location of a valet device. The valet device may be carried by the valet and may provide geolocation position information of the valet to the computing-device.

In another exemplary embodiment, the computing-device may estimate the time to deliver the vehicle is based on a method of travel by a valet.

In another exemplary embodiment, the computing-device may estimate the time to deliver the vehicle is based on a time estimated for the valet to traverse a route between the location of the valet and the location of the vehicle based on the method of travel by the valet.

In another exemplary embodiment, a system for summoning a vehicle using a patron's device which includes a processor programmed with instructions, for example a mobile device, is provided. A message containing a request to retrieve a vehicle is transmitted by the patron using the patron's device. The patron's device, may either automatically, periodically, and/or on demand, determine an estimated amount of time to deliver the vehicle. The estimated amount of time to deliver the vehicles may be determined based on an estimated amount of time to retrieve the vehicle, and/or an estimated amount of waiting time based on the request's position in a wait queue.

The patron's device may present an interface to the patron which allows the patron to request to be advanced in the wait queue. The patron's device may receive confirmation that the request should be advanced in the wait queue. The patron's device may then either automatically, periodically, and/or on demand, recalculate the estimated amount of time to deliver the vehicle based on an updated position for the request in the wait queue. The patron's device may collect a payment for retrieving the vehicle.

In an exemplary embodiment, the estimated amount of time to deliver the vehicle may be calculated using a valet device.

In an exemplary embodiment, the estimated amount of time to deliver the vehicle may be calculated using a remote server. The remote server may receive a geolocation, for example the results of a global positioning system (GPS) location determination, of the vehicle and/or the valet device and use the geolocation to either automatically, periodically, and/or on demand, determine the estimated amount of time to deliver the vehicle.

In an exemplary embodiment, the patron's device may acquire identifying information relating to a ticket issued to a user of the vehicle.

In determining the payment for retrieving the vehicle, the patron's device may include a fee for advancing the request of the patron in the wait queue. The patron's device may determine the fee based a number of positions that the request is advanced in the wait queue. The patron's device may determine the fee based on the request being advanced a predetermined number of positions in the wait queue. The patron's device may determine the payment for retrieving the vehicle includes a tip for a valet.

In another exemplary embodiment, the patron's device, valet device, and/or remote server may estimate the time to deliver the vehicle based on a location of the vehicle and a location of a valet device. The valet device may be carried by the valet and may provide geolocation position information of the valet to the computing-device.

In another exemplary embodiment, the patron's device, valet device, and/or remote server may estimate the time to deliver the vehicle is based on a method of travel by a valet.

In another exemplary embodiment, the patron's device, valet device, and/or remote server may estimate the time to deliver the vehicle is based on a time estimated for the valet to traverse a route between the location of the valet and the location of the vehicle based on the method of travel by the valet.

### BRIEF DESCRIPTION OF THE DRAWINGS

Having thus described some example embodiments in general terms, reference will now be made to the accompanying drawings, which are not necessarily drawn to scale, and wherein:

FIG. 1 is a flowchart depicting an exemplary method for managing a vehicle summoning service;

FIGS. 2A-2J depict exemplary interfaces for interacting with the vehicle summoning software;

FIG. 3 depicts an exemplary computer system suitable for use with exemplary embodiments of the present invention; and

FIG. 4 depicts an exemplary network implementation suitable for use with the present invention.

### DETAILED DESCRIPTION

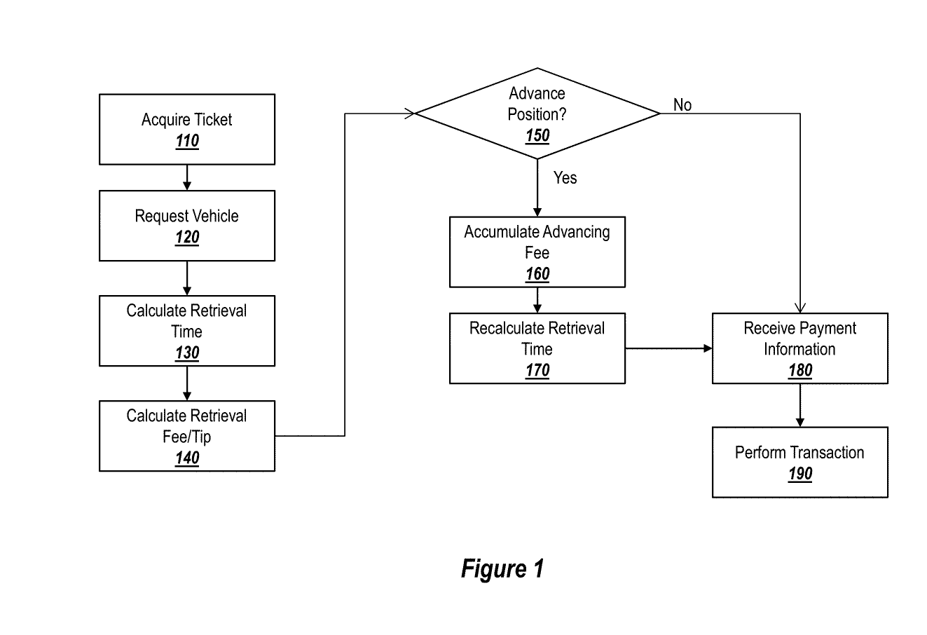

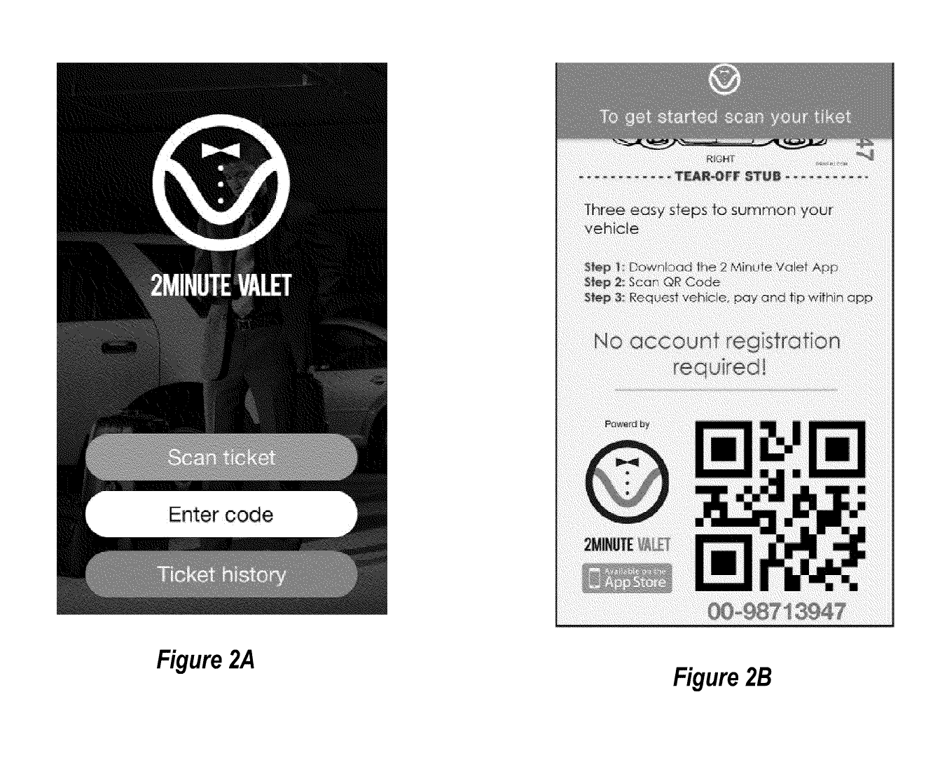

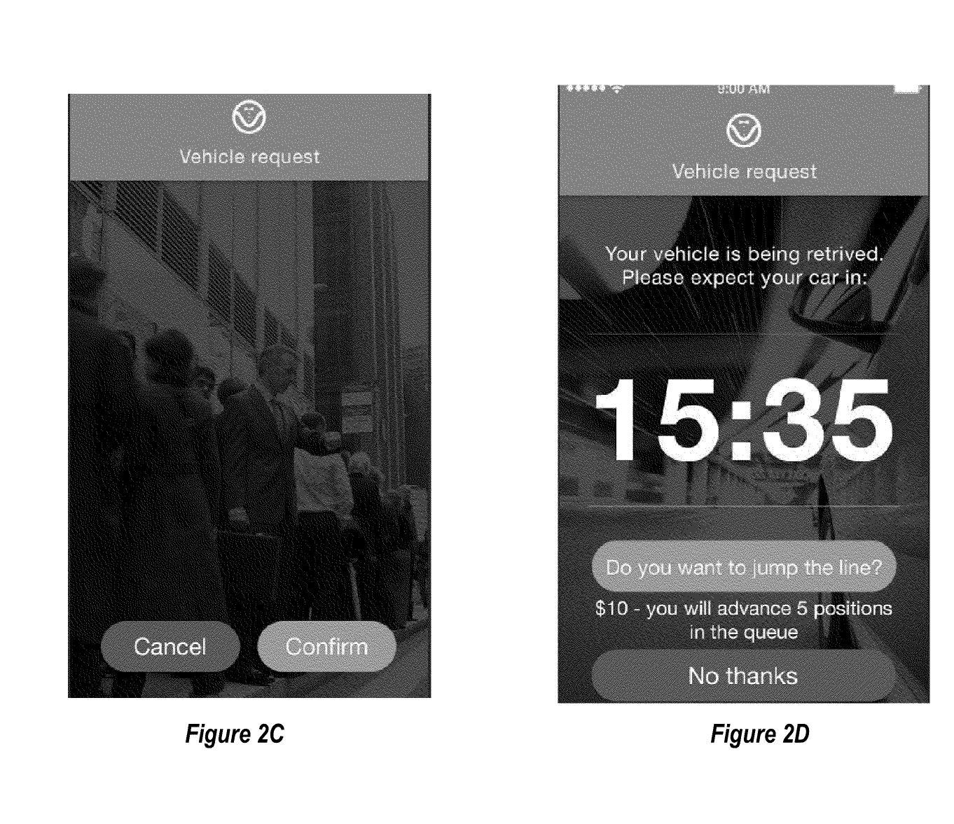

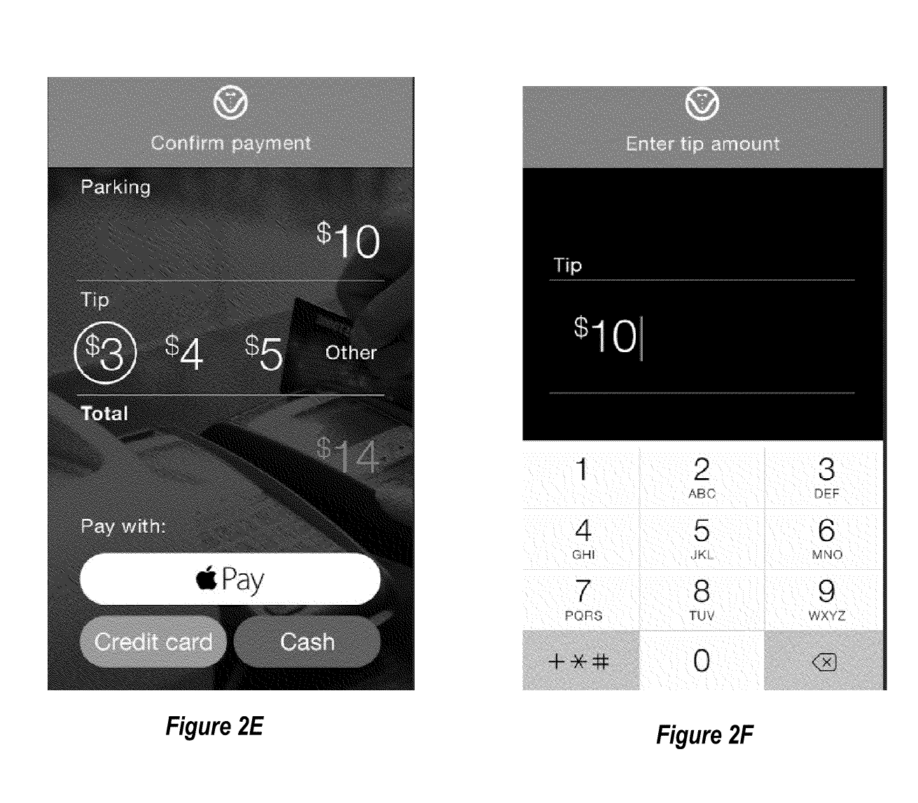

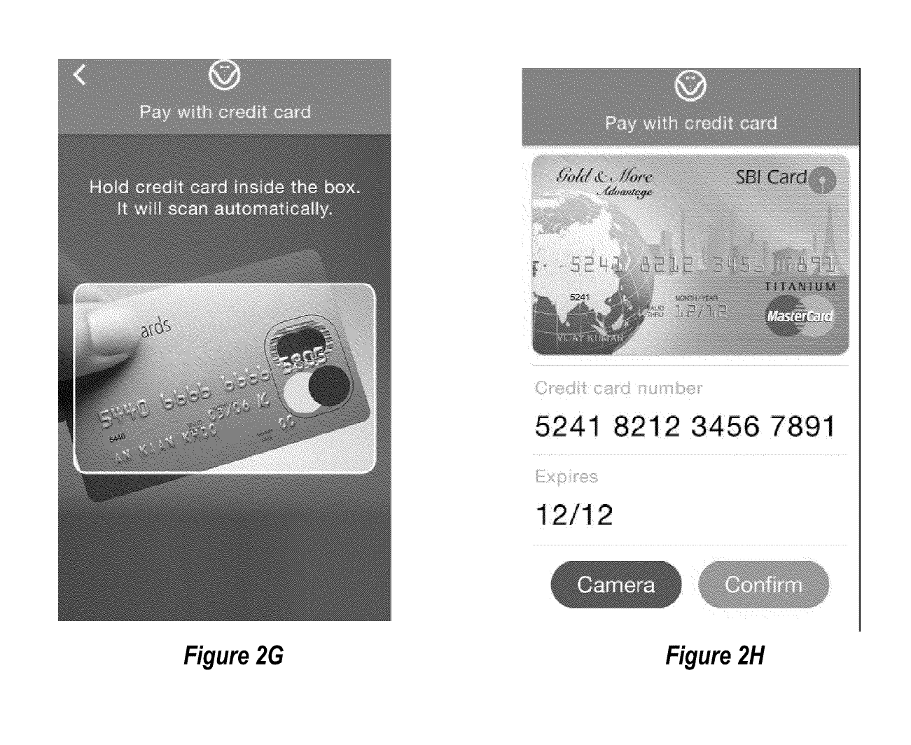

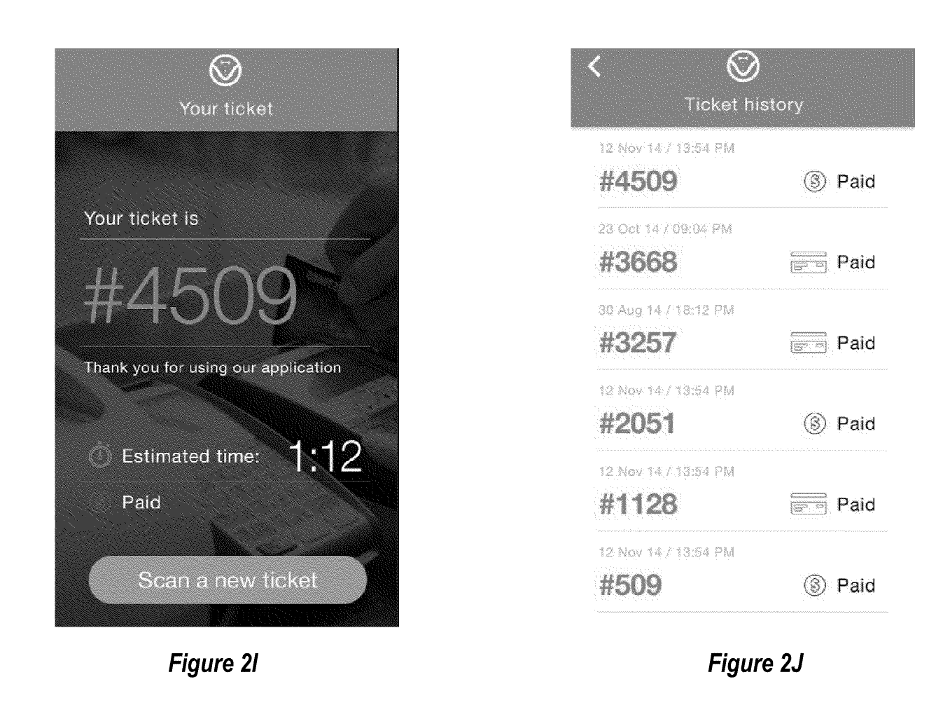

Exemplary embodiments are described with reference to the flowchart of FIG. 1 and the exemplary interfaces of FIGS. 2A-2J. Although the examples below will be described with reference to a valet service at a location such as a restaurant, one of ordinary skill in the art will recognize that the present invention is not limited to these examples. For example, the invention may be applied to any retrieval service in which time is required to retrieve the patron's belongings, such as a garage, coat check, bike check, or the like, among other possibilities. The retrieval of the object may be performed either manually, for example by a valet, or automatically, for example in the case of an automated garage or check system, as supported by the retrieval service.

Referring to FIG. 1, at step 110, a patron may hand over their vehicle to a valet and acquire a valet ticket. The ticket may be an electronic ticket issued to a software application on the patron's mobile device (such as a smartphone or tablet). Alternatively, or in addition, the valet service may use physical tickets with an identifier, such as a number, barcode, QR code, or other identifying information. The patron may use a camera of their mobile device (or other input means, such as manual input through a keyboard or a barcode scanner) to acquire the identifier and store the identifier. The identifier may be stored in a local storage of the mobile device, or may be stored remotely (e.g., on a remote server associated with the software application). Exemplary interfaces for receiving a ticket and converting a physical ticket into an electronic ticket are depicted in FIGS. 2A and 2B.

The valet may park the vehicle at a remote location and return to the valet stand. In some embodiments, the valet may be in possession of a valet mobile device with geolocation determination capability, for example a cellular device or a GPS device. Optionally, the valet mobile device may mark a location at which the vehicle has been parked, and store the location of the parked vehicle. The location of the parked vehicle may be stored locally on the valet mobile device in a memory device or remotely in a memory device (e.g., at a remote server maintained by a third party in association with providing the valet software application).

At step 120, the patron may use the software application to request that their vehicle be retrieved. The patron may be presented with an interface in the software application allowing the patron to request their vehicle. Optionally, the application may display an estimated amount of time required for vehicle retrieval (see step 130 below) before the vehicle is requested. Thus, a patron's device may either automatically, periodically, and/or on demand determine how long it will take for the vehicle to be retrieved. This feedback from the patron's device may allow the patron to plan their actions accordingly, possibly saving time and frustration for the patron while possibly increasing revenue for the valet service. FIG. 2C depicts an exemplary interface on the patron's device for requesting a patron's vehicle.

Once the patron requests that their vehicle be retrieved, the software application running on the patron's device may send a message to the valet service, which may be running a software application on a valet device that corresponds and interfaces to the patron's software application operating on the patron's electronic device. The message may be sent through a central server, sent directly to a valet's mobile device, and/or may be routed to a valet device at a valet stand. The patron's ticket identifier may be displayed on the valet's device, which may be used to identify the patron's vehicle for retrieval.

When the patron's retrieval request message is sent, the retrieval request message may be added to the end of a wait queue. If the patron's request is the only request in the wait queue, then the valet service may act upon the request immediately. If other requests have been received ahead of the patron's request, then the patron's request may be added to the end of the wait queue. Vehicles may be retrieved in the order in which corresponding requests are represented in the wait queue.

As vehicles are retrieved, patron requests may be removed from the wait queue and any requests remaining in the queue may be advanced. The retrieval of a vehicle may be manually indicated by the valet (e.g., by pressing a hardware or software button on the valet device clearing the vehicle's request from the wait queue). Alternatively, or in addition, retrieval of the vehicle may be determined programmatically. For example, the valet's mobile device may include a geolocation device, for example a GPS, which allows the location of the valet to be determined. When the valet returns to the location at which the vehicle is parked (the location of which may have been recorded in step 110), the valet's mobile device may acknowledge that the valet has acquired the vehicle. When the valet's mobile device subsequently detects that the valet has returned to the location of the valet stand, the valet's mobile device may identify that the patron's vehicle has been successfully retrieved. The valet may override this indication through the valet's software application.

At step 130, an estimated amount of time required to retrieve the vehicle may be calculated. The estimated amount of time may be calculated based on the wait queue (w), an estimated amount of time required for the valet to move from the valet stand to the vehicle's parked location (Tretrieve_patron), and an estimated amount of time required for the valet to drive the vehicle from the parked location back to the valet stand (Treturn_patron) as follows:

Estimated Amount of Time=w+tᵣₑₜᵣᵢₑᵥₑ_{_}ₚₐₜᵣₒₙ₊tᵣₑₜᵤᵣₙ_{_}ₚₐₜᵣₒₙ Equation 1

The estimated amount of time required for the valet to get to the vehicle's parked location may be calculated based on an estimated route that the valet may take to get to the vehicle's location and/or the valet's method of travel to the location. For example, if the valet decides to walk to the location of the parked vehicle, the valet's GPS device may plot a course to the vehicle using walking directions. The GPS device may estimate how long it will take the valet to walk to the parked vehicle, and store this value as Tretrieve_patron. In addition, the location of the valet and the estimated time for the valet to execute the planned route based on the valet's mode of travel may be provided to a patron's electronic device and/or a remote server.

The estimated amount of time required for the valet to return to the valet stand may be calculated based on an estimated route that the valet will take to get from the vehicle's location back to the valet stand using the vehicle. For example, the valet's GPS device may plot a course from the parked location to the valet stand using driving directions. The GPS device may estimate how long it will take the valet to drive the vehicle to the valet stand, and store this value as Treturn_patron.

The wait queue value (w) may be calculated by adding the Tretrieve_patron and Treturn_patron values for each of the other patrons {0, . . . n} ahead of the requesting patron in the wait queue, according to Equation 2:

$$w = {\sum }_{i = 0}^{n} {t}_{retrieve \_ patron \_ i} + {t}_{return \_ patron \_ i} \qquad Equation 2$$

A buffer (e.g., a multiple of n) may also be added to the wait queue value w to reflect the amount of time required to hand over the vehicle to its owner (as well as other incidental delays).

Alternatively, or in addition, any or all of the above-described variables used to calculate the estimated amount of time may be calculated based on an average amount of wait time per vehicle. The average amount of wait time per vehicle may be calculated on a rolling basis (e.g., based on the amount of time between the retrieval request and an indication of successful retrieval for a predetermined number of vehicles recently retrieved), or may be a predetermined amount based on historical observation, the time of day, the day of the week, and/or the time of year, among other possible factors. One of ordinary skill in the art will recognize that other methods for calculating the estimated wait time may also be used.

The estimated amount of time may be calculated locally, on the patron's mobile device, or remotely (e.g., at a remote server or at the valet's device). An interface for the patron mobile device displaying the estimated wait time is shown in FIG. 2D.

At step 140, a retrieval fee may be calculated. The retrieval fee may be a predetermined amount set by the valet service as a charge for using the valet service. In some cases, the retrieval fee may be zero (e.g., in the case where the valet service is provided at no fee, or solely on a tipped basis, or if the user has a discount code or coupon).

Additionally at step 140, the patron may be provided with an option to provide a tip to the valet. Predetermined tip amounts may be displayed (e.g., predetermined percentages of the retrieval fee, or predetermined dollar amounts such as $2, $5, etc.), and/or the patron may be permitted to enter a custom tip amount. The tip amount may be added to the retrieval fee.

Exemplary interfaces for providing a tip are depicted in FIGS. 2E and 2F.

At step 150, an interface may be displayed presenting the patron with the opportunity to advance their position in the wait queue. For example, the patron may be presented with an option to pay an advancing fee (e.g., $10) to move forward in the wait queue.

The fee may be variable, for example depending on the current demand for valet services. The fee may alternatively be a predetermined amount. Alternatively, or in addition, the fee may escalate in a linear or non-linear manner depending on the number of positions that the patron wishes to advance (e.g., the patron may pay $2 to advance one position in line, or $5 to advance two positions in line, etc.). The patron may be provided with an opportunity to advance a fixed number of positions (e.g., five positions), or the patron may select the number of positions that the patron wishes to advance. An advancing fee may be calculated based on some or all of the above factors and presented to the patron to accept or reject. The interface of FIG. 2D includes an exemplary software button allowing the patron to request that their position in the wait queue be advanced.

If the answer at step 150 is “NO” (i.e., the patron does not want to advance their position in the wait queue), then processing may proceed to step 180, where the patron has the opportunity to pay their retrieval fee and any tip amount entered at step 140.

If the answer at step 150 is “YES” (i.e., the patron does wish to advance their position in the wait queue), then processing may proceed to step 160. At step 160, the advancing fee calculated in step 160 may be added to the retrieval fee and tip calculated at step 140. An advancement message may be generated and transmitted to the valet device (or an intermediate server) instructing that the patron should be advanced in the queue by the number of positions designated at step 150.

At step 170, the estimated retrieval time may be recalculated using the updated wait queue position. The estimated retrieval time may be recalculated using the technique described in step 140, but with an updated value for the number of remaining patrons (n) in the calculation of the wait time (w) variable value. Processing may then proceed to step 180.

At step 180, the application may collect the patron's payment information. For example, the patron may be presented with options to pay the valet with cash, credit card, or a mobile payment service.

If the patron selects “cash,” a message may be sent to the valet device indicating that the valet must collect payment from the driver.

If the patron selects a credit card, the software application may allow the user to select a payment method from one or more pre-stored credit cards. Alternatively, or in addition, the patron may enter information describing a new credit card to be used. The new information may be entered, for example, by inputting identifying information about the credit card into the application via keyboard or voice, by a credit card magnetic stripe or chip reader, or by wirelessly reading the credit card's information, e.g., via radio frequency identifier (RFID) or near field communicator (NFC). Alternatively, or in addition, the new information may be gathered directly from an image of the credit card, such as an image acquired by the mobile device's camera.

If the patron selects a mobile payment service, the user may be prompted to provide authentication credentials that allow the user to be logged in to the service. The authentication credentials may include, for example, a login name and password, or biometric identifying information such as a fingerprint.

Exemplary interfaces for collecting the patron's payment information are depicted in FIGS. 2G and 2H.

At step 190, the payment information collected at step 180 may be used to perform a financial transaction. If the patron selected a credit card in step 180, the credit card information may be processed by a processing authority. If the patron selected a mobile payment service in step 180, then the fee(s) calculated in steps 140 and 160 may be deducted from an account associated with the patron in the mobile payment service.

Once payment is confirmed, a message may be sent to the valet device indicating that the patron has paid and that the vehicle may be released. The message may include an indication of an amount of tip that the patron provided to the valet, so that the valet can collect an appropriate amount from the valet service.

Following payment, a receipt may be sent to the patron's software application operating on the patron's electronic device. The application may display the patron's ticket identifier and an estimated amount of time required before the vehicle is retrieved, a shown in FIG. 21. The application may also display historical usage history, including previous ticket numbers, dates on which the valet service was used, and whether and how the patron paid for the valet service, as shown in FIG. 2J.

### Computer-Implemented Embodiments

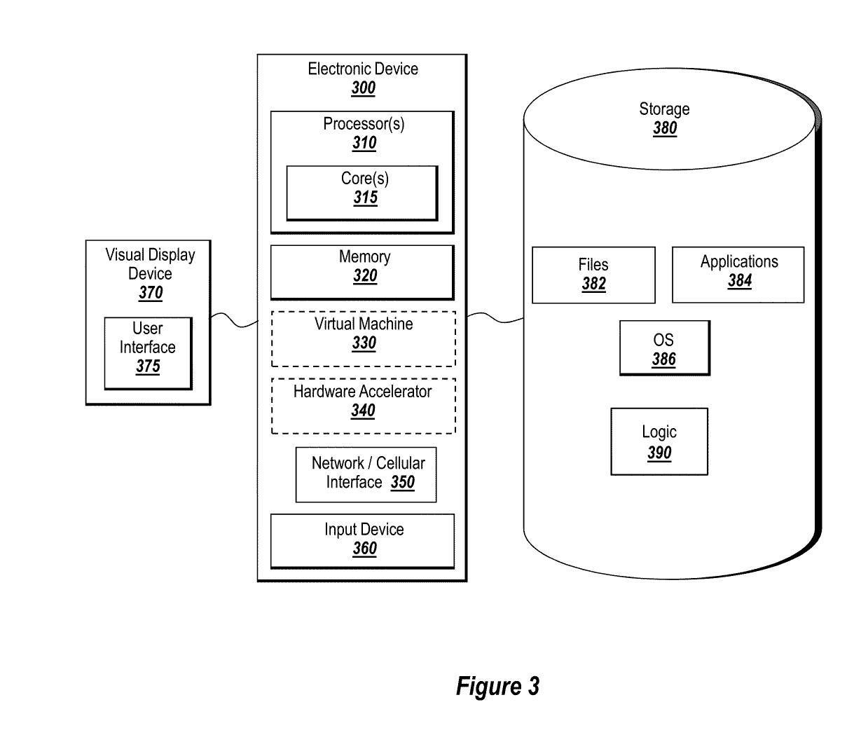

One or more of the above-described acts may be encoded as computer-executable instructions executable by processing logic. The computer-executable instructions may be stored on one or more non-transitory computer readable media. One or more of the above described acts may be performed in a suitably-programmed electronic device. FIG. 3 depicts an example of an electronic device 300 that may be suitable for use with one or more acts disclosed herein.

The electronic device 300 may take many forms, including but not limited to a computer, workstation, server, network computer, optical computer, Internet appliance, mobile device, a pager, a tablet computer, a smart sensor, application specific processing device, etc.

The electronic device 300 is illustrative and may take other forms. For example, an alternative implementation of the electronic device 300 may have fewer components, more components, or components that are in a configuration that differs from the configuration of FIG. 3. The components of FIG. 3 and/or other figures described herein may be implemented using hardware based logic, software based logic and/or logic that is a combination of hardware and software based logic (e.g., hybrid logic); therefore, components illustrated in FIG. 3 and/or other figures are not limited to a specific type of logic.

The processor 310 may include hardware based logic or a combination of hardware based logic and software to execute instructions on behalf of the electronic device 300. The processor 310 may include logic that may interpret, execute, and/or otherwise process information contained in, for example, the memory 320. The information may include computer-executable instructions and/or data that may implement one or more embodiments of the invention. The processor 310 may comprise a variety of homogeneous or heterogeneous hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), or other types of processing logic that may interpret, execute, manipulate, and/or otherwise process the information. The processor may include a single core or multiple cores 315. Moreover, the processor 310 may include a system-on-chip (SoC) or system-in-package (SiP). An example of a processor 310 is the Intel® Xeon® processor available from Intel Corporation, Santa Clara, Calif.

The electronic device 300 may include one or more tangible non-transitory computer-readable storage media for storing one or more computer-executable instructions or software that may implement one or more embodiments of the invention. The non-transitory computer-readable storage media may be, for example, the memory 320 or the storage 380. The memory 320 may comprise a RAM that may include RAM devices that may store the information. The RAM devices may be volatile or non-volatile and may include, for example, one or more DRAM devices, flash memory devices, SRAM devices, zero-capacitor RAM (ZRAM) devices, twin transistor RAM (TTRAM) devices, read-only memory (ROM) devices, ferroelectric RAM (FeRAM) devices, magneto-resistive RAM (MRAM) devices, phase change memory RAM (PRAM) devices, or other types of RAM devices.

The electronic device 300 may include a virtual machine (VM) 330 for executing instructions loaded in the memory 320. A virtual machine 330 may be provided to handle a process running on multiple processors so that the process may appear to be using only one computing resource rather than multiple computing resources. Virtualization may be employed in the electronic device 300 so that infrastructure and resources in the electronic device may be shared dynamically. Multiple VMs 330 may be resident on a single computing device 300.

A hardware accelerator 340, may be implemented in an ASIC, FPGA, or some other device. The hardware accelerator 340 may be used to reduce the general processing time of the electronic device 300.

The electronic device 300 may include a network/cellular interface 350 to interface to a Local Area Network (LAN), Wide Area Network (WAN), cellular communications network, and/or the Internet through a variety of connections including, but not limited to, mobile communication, standard telephone lines, LAN or WAN links (e.g., T1, T3, 56 kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. The network interface 350 may include a built-in network adapter, network interface card, personal computer memory card international association (PCMCIA) network card, card bus network adapter, wireless network adapter, universal serial bus (USB) network adapter, modem or any other device suitable for interfacing the electronic device 300 to any type of network capable of communication and performing the operations described herein.

The electronic device 300 may include one or more input devices 360, such as a keyboard, an interactive whiteboard, a multi-point touch interface, a pointing device (e.g., a mouse), a gyroscope, an accelerometer, a haptic device, a tactile device, a neural device, a microphone, or a camera that may be used to receive input from, for example, a user. Note that electronic device 300 may include other suitable I/O peripherals.

The input devices 360 may allow a user to provide input that is registered on a visual display device 370. A graphical user interface (GUI) 375 may be shown on the display device 370.

A storage device 380 may also be associated with the electronic device 300. The storage device 380 may be accessible to the processor 310 via an I/O bus. The information in the storage device 380 may be executed, interpreted, manipulated, and/or otherwise processed by the processor 310. The storage device 380 may include, for example, a magnetic disk, optical disk (e.g., CD-ROM, DVD player), random-access memory (RAM) disk, tape unit, and/or flash drive. The information may be stored on one or more non-transient tangible computer-readable media contained in the storage device. This media may include, for example, magnetic discs, optical discs, magnetic tape, and/or memory devices (e.g., flash memory devices, static RAM (SRAM) devices, dynamic RAM (DRAM) devices, or other memory devices). The information may include data and/or computer-executable instructions that may implement one or more embodiments of the invention

The storage device 380 may be used for storing one or more files 382 and applications 384. The electronic device 310 can further be running an operating system (OS) 386. Examples of OS 386 may include the Apple iOS, Google Android, Microsoft Windows operating systems, the Unix and Linux operating systems, the MacOS for Macintosh computers, an embedded operating system, such as the Symbian OS, a real-time operating system, an open source operating system, a proprietary operating system, operating systems for mobile electronic devices, or other operating system capable of running on the electronic device and performing the operations described herein. The operating system may be running in native mode or emulated mode.

Additionally, the storage device 380 may store logic 390 for carrying out any of the above-described actions.

One or more embodiments of the invention may be implemented using computer-executable instructions and/or data that may be embodied on one or more non-transitory tangible computer-readable mediums. The mediums may be, but are not limited to, a hard disk, a compact disc, a digital versatile disc, a flash memory card, a Programmable Read Only Memory (PROM), a Random Access Memory (RAM), a Read Only Memory (ROM), Magnetoresistive Random Access Memory (MRAM), a magnetic tape, or other computer-readable media.

One or more embodiments of the invention may be implemented in a programming language. Some examples of languages that may be used include, but are not limited to, Python, C, C++, C#, SystemC, Java, Javascript, a hardware description language (HDL), unified modeling language (UML), and Programmable Logic Controller (PLC) languages. Further, one or more embodiments of the invention may be implemented in a hardware description language or other language that may allow prescribing computation. One or more embodiments of the invention may be stored on or in one or more mediums as object code. Instructions that may implement one or more embodiments of the invention may be executed by one or more processors. Portions of the invention may be in instructions that execute on one or more hardware components other than a processor.

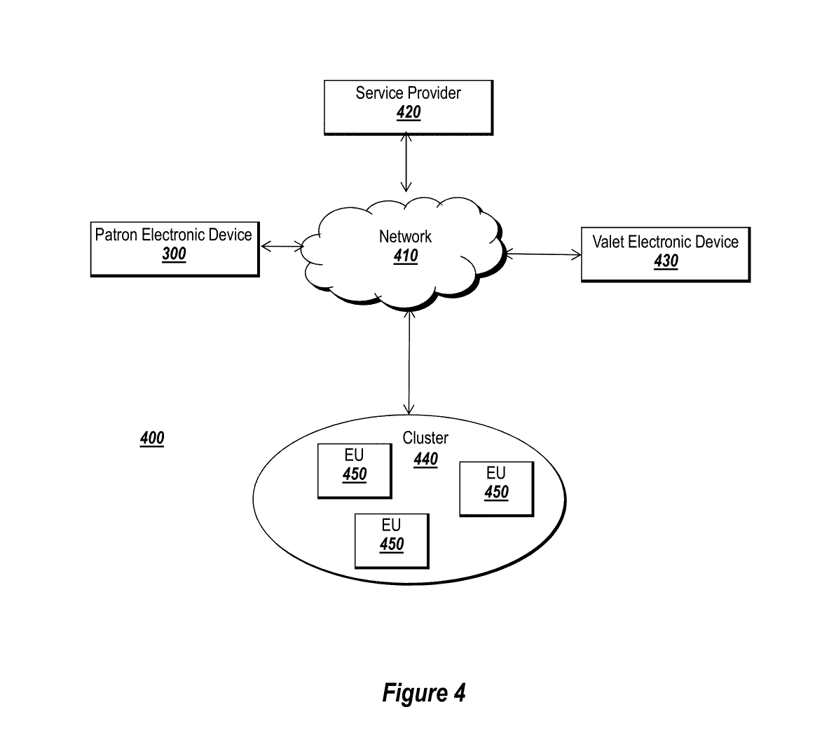

In some embodiments, the electronic device 300 may be part of a network implementation. FIG. 4 depicts an exemplary network implementation that may implement one or more embodiments of the invention. A system 400 may include a patron's electronic device 300, a network 410, a service provider 420, a target environment 430, for example a valet electronic device, and a cluster 440. The embodiment of FIG. 4 is exemplary, and other embodiments can include more devices, fewer devices, or devices in arrangements that differ from the arrangement of FIG. 4.

The network 410 may transport data from a source to a destination. Embodiments of the network 410 may use network devices, such as routers, switches, firewalls, and/or servers (not shown) and connections (e.g., links) to transport data. Data may refer to any type of machine-readable information having substantially any format that may be adapted for use in one or more networks and/or with one or more devices (e.g., the patron's electronic device 300, the service provider 420, etc.). Data may include digital information or analog information. Data may further be packetized and/or non-packetized.

The network 410 may be a hardwired network using wired conductors and/or optical fibers and/or may be a wireless network using free-space optical, radio frequency (RF), and/or acoustic transmission paths. In one implementation, the network 410 may be a substantially open public network, such as the Internet. In another implementation, the network 410 may be a more restricted network, such as a corporate virtual network. The network 410 may be the Internet, an intranet, Local Area Network (LAN), Wide Area Network (WAN), Metropolitan Area Network (MAN), wireless network (e.g., using IEEE 802.11), or other types of network. The network 410 may use middleware, such as Common Object Request Broker Architecture (CORBA) or Distributed Component Object Model (DCOM). Implementations of networks and/or devices operating on networks described herein are not limited to, for example, any particular data type, protocol, and/or architecture/configuration.

The service provider 420 may include a device that makes a service available to another device. For example, the service provider 420 may include an entity (e.g., an individual, a corporation, an educational institution, a government agency, etc.) that provides one or more services to a destination using a server and/or other devices. Services may include instructions that are executed by a destination to perform an operation (e.g., an optimization operation). Alternatively, a service may include instructions that are executed on behalf of a destination to perform an operation on the destination's behalf.

A valet electronic device 430 may be used to track the location of a valet and the location at which the valet parks the patrons' vehicle. Information from the valet electronic device 430 may be uploaded to the service provider 420, which the patron electronic device 300 may contact in order to determine an estimated wait time for retrieving the vehicle. The service provider 420 may calculate the estimated wait time based on previously stored inputs from the valet electronic device 430 and/or other information stored at the service provider 420.

A cluster 440 may include a number of Execution Units (EUs) 450 and may perform processing on behalf of the electronic device 300 and/or another device, such as the service provider 420. For example, the cluster 440 may perform parallel processing on an operation received from the patron's electronic device 300. The cluster 440 may include EUs 450 that reside on a single device or chip or that reside on a number of devices or chips.

The EUs 450 may include processing devices that perform operations on behalf of a device, such as a requesting device. An EU may be a microprocessor, field programmable gate array (FPGA), and/or another type of processing device. EU 450 may include code, such as code for an operating environment. For example, an EU 450 may run a portion of an operating environment that pertains to parallel processing activities. The service provider 420 may operate the cluster 440 and may provide interactive optimization capabilities to the patron's electronic device 300 on a subscription basis (e.g., via a web service).

EUs 450 may provide remote/distributed processing capabilities for software products. A hardware EU may include a device (e.g., a hardware resource) that may perform and/or participate in parallel programming activities. For example, a hardware EU may perform and/or participate in parallel programming activities in response to a request and/or a task it has received (e.g., received directly or via a proxy). A hardware EU may perform and/or participate in substantially any type of parallel programming (e.g., task, data, stream processing, etc.) using one or more devices. For example, a hardware EU may include a single processing device that includes multiple cores or a number of processors. A hardware EU may also be a programmable device, such as a field programmable gate array (FPGA), an application specific integrated circuit (ASIC), a digital signal processor (DSP), or other programmable device. Devices used in a hardware EU 450 may be arranged in many different configurations (or topologies), such as a grid, ring, star, or other configuration. A hardware EU may support one or more threads (or processes) when performing processing operations.

A software EU may include a software resource (e.g., a technical computing environment) that may perform and/or participate in one or more parallel programming activities. A software EU may perform and/or participate in one or more parallel programming activities in response to a receipt of a program and/or one or more portions of the program. A software EU may perform and/or participate in different types of parallel programming using one or more hardware units of execution. A software EU may support one or more threads and/or processes when performing processing operations.

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware.

Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

No element, act, or instruction used in the description of the invention should be construed critical or essential to the invention unless explicitly described as such. Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, an electronic device (e.g., a workstation) or a user of a electronic device, unless otherwise stated.

It is intended that the invention not be limited to the particular embodiments disclosed above, but that the invention will include any and all particular embodiments and equivalents falling within the scope of the following appended claims.

That which is claimed:

1. A computing-device implementation method for remotely summoning a vehicle, comprising:
transmitting a message containing a request to retrieve the vehicle;
calculating an estimated amount of time to deliver the vehicle based on an estimated amount of time to retrieve the vehicle and an estimated amount of waiting time based on the request's position in a wait queue;
presenting an interface allowing the request to be advanced in the wait queue;
receiving confirmation that the request should be advanced in the wait queue;
recalculating the estimated amount of time to deliver the vehicle based on an updated position for the request in the wait queue; and
collecting a payment for retrieving the vehicle.

2. The method of claim 1, further comprising:
acquiring identifying information relating to a ticket issued to a user of the vehicle.

3. The method of claim 1, wherein the payment for retrieving the vehicle includes a fee for advancing the request in the wait queue.

4. The method of claim 3, wherein the fee is determined based a number of positions that the request is advanced in the wait queue.

5. The method of claim 1, wherein the request is advanced a predetermined number of positions in the wait queue.

6. The method of claim 1, wherein the payment for retrieving the vehicle includes a tip for a valet.

7. The method of claim 1, wherein the estimated amount of time to deliver the vehicle is based on a location of the vehicle and a location of a valet device.

8. The method of claim 7, wherein the estimated amount of time to deliver the vehicle is further based on a method of travel by a valet.

9. The method of claim 8, wherein the estimated amount of time to deliver the vehicle is further based on an estimated time for the valet to traverse a route between the location of the valet and the location of the vehicle based on the method of travel by the valet.

10. A system for remotely summoning a vehicle, comprising:
a patron device, including a processor programmed with instructions that, when executed, causes the patron device to:
transmit a message containing a request to retrieve the vehicle;
determine an estimated amount of time to deliver the vehicle based on an estimated amount of time to retrieve the vehicle and an estimated amount of waiting time based on the request's position in a wait queue;
present an interface allowing the request to be advanced in the wait queue;
receive confirmation that the request should be advanced in the wait queue;
determine a recalculated estimated amount of time to deliver the vehicle based on an updated position for the request in the wait queue; and
collect a payment for retrieving the vehicle.

11. The system of claim 10, wherein the estimated amount of time to deliver the vehicle is determined at a valet device.

12. The system of claim 10, wherein the estimated amount of time to deliver the vehicle is determined at a remote server.

13. The system of claim 10, wherein the estimated amount of time to deliver the vehicle is based on a location of the vehicle and a location of a valet device.

14. The system of claim 10, wherein the patron device acquires identifying information relating to a ticket issued to a user of the vehicle.

15. The system of claim 10, wherein the payment for retrieving the vehicle includes a fee for advancing the request in the wait queue.

16. The system of claim 15, wherein the fee is determined based a number of positions that the request is advanced in the wait queue.

17. The system of claim 10, wherein the request is advanced a predetermined number of positions in the wait queue.

18. The system of claim 10, wherein the estimated amount of time to deliver the vehicle is based on a location of the vehicle and a location of a valet device.

19. The system of claim 18, wherein the estimated amount of time to deliver the vehicle is further based on a method of travel by a valet.

20. The system of claim 19, wherein the estimated amount of time to deliver the vehicle is further based on an estimated time for the valet to traverse a route between the location of the valet and the location of the vehicle based on the method of travel by the valet.
